(19) United States
(12) Patent Application Publication
(10) Pub. No.: US 2025/0273035 A1
(43) Pub. Date: Aug. 28, 2025

(54) TABLEWARE VENDING MACHINE

(71) Applicant: IBASE SOLUTION CO., LTD, New Taipei City (TW)

(72) Inventor: Lian-Bin LIAO, New Taipei City (TW)

(21) Appl. No.: 19/009,510

(22) Filed: Jan. 3, 2025

(30) Foreign Application Priority Data
Feb. 26, 2024 (TW) 113201957

(51) Int. Cl. G07F 17/00; G07F 11/38

(52) U.S. Cl. CPC G07F 17/0042; G07F 11/38

(57) ABSTRACT

A tableware vending machine includes a machine body having a frame and a shell wrapped around the frame and provided with an outlet, a carrying mechanism disposed on the frame and corresponding to the outlet, an electronic control mechanism disposed on one side of the shell and adjacent to the outlet, a driving mechanism disposed on the carrying mechanism and electrically connected to the electronic control mechanism and a tableware storage mechanism disposed on the driving mechanism. Thus, tableware can be placed on the tableware storage mechanism, and the driving mechanism can be activated by the electronic control mechanism, and the driving mechanism can output the tableware in the tableware storage mechanism, thereby effectively managing the supply of tableware, maintaining a sanitary environment for tableware storage, and meeting environmental protection requirements for tableware use.

This application claims the priority benefit of Taiwan patent application number 113201957, filed on Feb. 26, 2024.

### BACKGROUND OF THE INVENTION

### 1. Field of the Invention

The present invention provides a tableware vending machine, in particular, a tableware vending machine that can effectively manage the supply of tableware, maintain a sanitary environment for tableware storage, and at the same time meet the environmental protection requirements for the use of tableware.

### 2. Description of the Related Art

For general vending machine operators, the way they provide tableware is usually to place a bucket outside the vending machine and then place most of the tableware in the bucket for consumers to take by themselves.

However, according to current regulations, this method is not only unable to effectively manage tableware, but also leads to hygiene concerns about the storage of tableware and environmental issues in its use.

In view of the above-mentioned shortcomings of the known technology, the inventor felt that it was not perfect, so he used all his mind to carefully research and overcome it, and then developed a tableware vending machine, in the hope that it can effectively manage the supply of tableware, maintain a sanitary environment for tableware storage, and at the same time meet the environmental protection needs of tableware use.

### SUMMARY OF THE INVENTION

To achieve the above and other purposes, the present invention provides a tableware vending machine, which comprises: a machine body, at least one carrying mechanism, an electronic control mechanism, at least one driving mechanism and at least one tableware storage mechanism. The machine body includes a frame and a shell. The shell is wrapped around the outer side of the frame and has an outlet. The carrying mechanism is located on the frame and corresponds to the outlet. The electronic control mechanism is located on one side of the shell and adjacent to the outlet. The driving mechanism is disposed on the carrying mechanism and is electrically connected to the electronic control mechanism. The tableware storage mechanism is disposed on the driving mechanism.

Preferably, in the tableware vending machine, the carrying mechanism comprises a base and a tableware slide way. The base is disposed on the frame, the tableware slide way is disposed at one end of the base and corresponds to the outlet, and the driving mechanism and the tableware storage mechanism are disposed on the base.

Preferably, in the tableware vending machine, the electronic control mechanism comprises a human-machine interface, a billing module and an electronic control module, and the human-machine interface, the billing module and the driving mechanism are electrically connected to the electronic control module.

Preferably, in the tableware vending machine, the driving mechanism comprises a carrier, a drive module and a detection module, wherein the carrier is disposed on the carrying mechanism, the drive module is disposed between the carrier and the carrying mechanism, the detection module is disposed at one end of the carrier and is electrically connected to the electronic control mechanism, and the tableware storage mechanism is assembled with the carrier of the driving mechanism.

Preferably, in the tableware vending machine, the drive module comprises a first slide rail set, a second slide rail set, a push screw, a screw drive motor, a push wheel and a push wheel drive motor, wherein the first slide rail set is disposed between the carrying mechanism and the carrier, the second slide rail set is disposed between the tableware storage mechanism and the carrier, the push screw is connected to the tableware storage mechanism, the screw drive motor is connected to the push screw, the push wheel is disposed on the tableware storage mechanism, the push wheel drive motor is connected to the push wheel, and the screw drive motor and the push wheel drive motor are electrically connected to the electronic control mechanism.

Preferably, in the tableware vending machine, the tableware storage mechanism comprises a tableware box storage module, a plurality of tableware boxes and a fixing module, wherein the tableware box storage module is located on the driving mechanism, each tableware box is respectively arranged on the tableware box storage module, and the fixing module is arranged between the tableware box storage module and the driving mechanism.

Thus, the tableware vending machine of the present invention can place tableware on the tableware storage mechanism and use the electronic control mechanism to start the driving mechanism, which outputs the tableware in the tableware storage mechanism, thereby effectively managing the supply of tableware, maintaining a sanitary environment for tableware storage, and meeting environmental protection requirements for the use of tableware.

### BRIEF DESCRIPTION OF THE DRAWINGS

FIG. 1 is a schematic diagram of the appearance of the tableware vending machine of the present invention.

FIG. 2 is a schematic diagram of the tableware vending machine of the present invention, excluding the machine body and the electronic control mechanism.

FIG. 3 is a schematic diagram showing the tableware vending machine in use without the machine body and electronic control mechanism (I).

FIG. 4 is a schematic diagram showing the tableware vending machine in use without the machine body and electronic control mechanism (II).

FIG. 5 is a schematic diagram showing the tableware vending machine in use without the machine body and electronic control mechanism (III).

### DETAILED DESCRIPTION OF THE PREFERRED EMBODIMENT

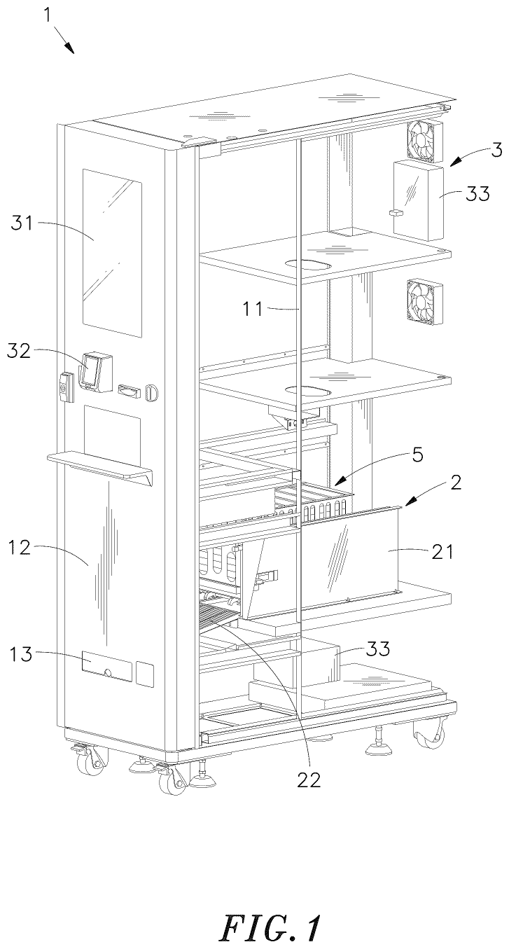

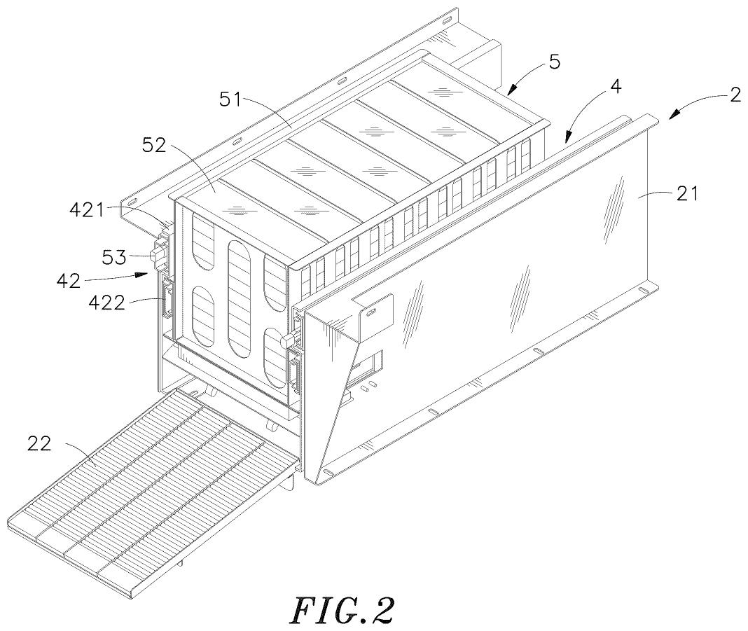

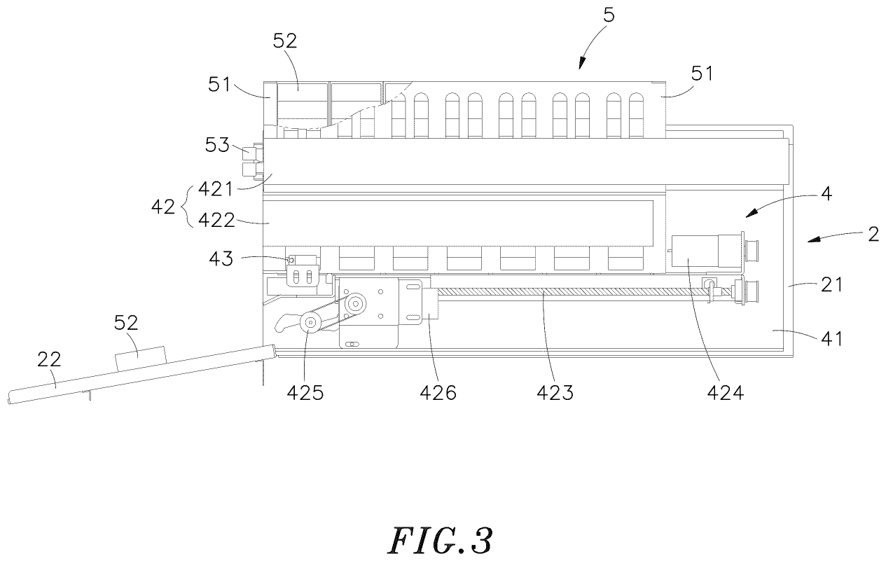

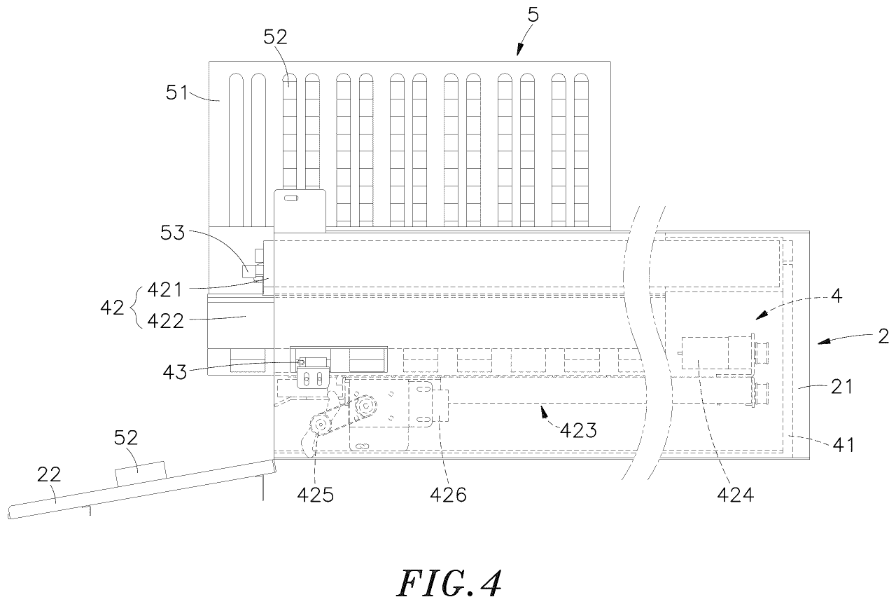

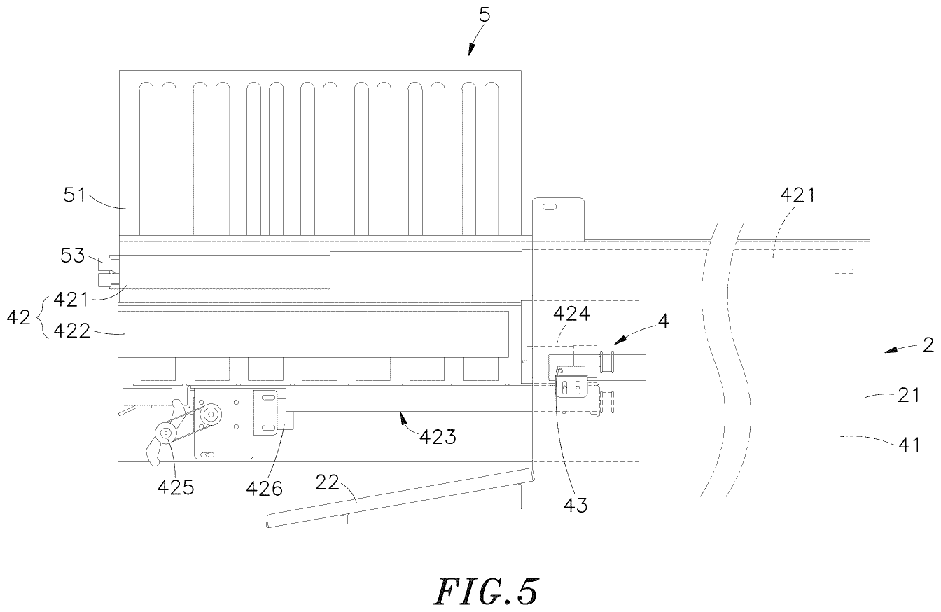

In order to fully understand the purpose, features and effects of this invention, the following specific preferred embodiments and the accompanying drawings are used to explain this invention in detail. Please refer to FIGS. 1-5. As shown in the figures, the present invention provides a tableware vending machine, comprising a machine body 1, at least one carrying mechanism 2, an electronic control mechanism 3, at least one driving mechanism 4 and at least one tableware storage mechanism 5.

The machine body 1 comprises a frame 11, and a shell 12 wrapped around the outer side of the frame 11. The shell 12 has an outlet 13.

The carrying mechanism 2 is disposed on the frame 11 and corresponds to the outlet 13.

The electronic control mechanism 3 is disposed on one side of the shell 12 and adjacent to the outlet 13.

The driving mechanism 4 is disposed on the carrying mechanism 2 and is electrically connected to the electronic control mechanism 3.

The tableware storage mechanism 5 is disposed on the driving mechanism 4.

When the tableware vending machine of the invention is used, most tableware can be placed on the tableware storage mechanism 5. When the user wants to use the tableware, he or she can start the tableware or start the tableware after paying on the electronic control mechanism 3. After the electronic control mechanism 3 is activated, an action command can be output to the driving mechanism 4, so that the driving mechanism 4 drives the tableware storage mechanism 5 to output the tableware in the tableware storage mechanism 5 from the outlet 13. In this way, the electronic control mechanism 3 can be used to activate the driving mechanism 4, and the tableware in the tableware storage mechanism 5 can be output by the driving mechanism 4, thereby effectively managing the supply of tableware, maintaining a sanitary environment for tableware storage, and meeting environmental protection requirements for tableware use.

In one embodiment of the present invention, the difference from the above-mentioned embodiment is that the carrying mechanism 2 comprises a base 21 and a tableware slide way 22. The base 21 is disposed on the frame 11. The tableware slide way 22 is disposed at one end of the base 21 and corresponds to the outlet 13. The driving mechanism 4 and the tableware storage mechanism 5 are disposed on the base 21. Thus, when the driving mechanism 4 drives the tableware storage mechanism 5, the tableware in the tableware storage mechanism 5 can be output from the outlet 13 via the tableware slide way 22, so as to achieve smoothness and convenience in outputting the tableware.

In one embodiment of the present invention, the difference from the above embodiments is that the electronic control mechanism 3 comprises a human-machine interface 31, a billing module 32 and an electronic control module 33. The human-machine interface 31, the billing module 32 and the driving mechanism 4 are electrically connected to the electronic control module 33. Thus, when the user wants to use the tableware, the human-machine interface 31 of the electronic control mechanism 3 can cooperate with the billing module 32 to start the electronic control module 33 by executing the start-up or executing the start-up after payment. After the electronic control module 33 of the electronic control mechanism 3 is activated, an action command can be output to the driving mechanism 4, so that the driving mechanism 4 drives the tableware storage mechanism 5 to output the tableware in the tableware storage mechanism 5 through the tableware slide way 22 and the outlet 13. In this way, the electronic control mechanism 3 can be used to activate the driving mechanism 4, and the tableware in the tableware storage mechanism 5 can be output by the driving mechanism 4, thereby effectively managing the supply of tableware, maintaining a sanitary environment for tableware storage, and meeting environmental protection requirements for tableware use.

In addition, the electronic control module 33 of the electronic control mechanism 3 can not only be connected to external power, but also set and store the storage quantity and position of each tableware in the tableware storage mechanism 5, so as to control the output quantity and storage quantity of the tableware.

In one embodiment of the present invention, the difference from the above embodiments is that the driving mechanism 4 comprises a carrier 41, a drive module 42 and a detection module 43. The carrier 41 is disposed at the base 21 of the carrying mechanism 2. The drive module 42 is disposed between the carrier 41 and the base 21 of the carrying mechanism 2. The detection module 43 is disposed at one end of the carrier 41 and is electrically connected to the electronic control module 33 of the electronic control mechanism 3. The tableware storage mechanism 5 is assembled with the carrier 41. The detection module 43 can detect the amount of tableware in the tableware storage mechanism 5. The drive module 42 comprises a first slide rail set 421, a second slide rail set 422, a push screw 423, a screw drive motor 424, a push wheel 425 and a push wheel drive motor 426. The first slide rail set 421 is disposed between the base 21 of the carrying mechanism 2 and the carrier 41. The second slide rail set 422 is disposed between the tableware storage mechanism 5 and the carrier 41. The push screw 423 is connected to the tableware storage mechanism 5. The screw drive motor 424 is connected to the push screw 423. The push wheel 425 is disposed on the tableware storage mechanism 5. The push wheel drive motor 426 is connected to the push wheel 425. The screw drive motor 424 and the push wheel drive motor 426 are electrically connected to the electronic control module 33 of the electronic control mechanism 3.

In one embodiment of the present invention, the difference from the above embodiments is that the tableware storage mechanism 5 comprises a tableware box storage module 51, a plurality of tableware boxes 52 and a fixing module 53. The tableware box storage module 51 is disposed on the second slide rail set 422 of the driving mechanism 4 and connected to the push screw 423. Each tableware box is respectively disposed on the tableware box storage module and abuts against the push wheel 425. The fixing module 53 is disposed between the tableware box storage module 51 and the carrier 41 of the driving mechanism 4.

Based on the above-mentioned embodiment, when the tableware vending machine of the present invention is used, a plurality of tableware can be placed in each tableware box 52 of the tableware storage mechanism 5, and each tableware box 52 can be stacked and arranged in the tableware box storage module 51 (for example, each tableware box 52 can be arranged to be stacked in at least seven rows), so as to store a predetermined amount of tableware in the tableware storage mechanism 5, and the tableware box storage module 51 is fixed to the carrier 41 by the fixing module 53 to maintain the stability of the tableware storage mechanism 5 when in use.

When the user wants to use the tableware, the human-machine interface 31 of the electronic control mechanism 3 can cooperate with the billing module 32 to start the electronic control module 33 by executing the start-up or executing the start-up after payment action. After the electronic control module 33 of the electronic control mechanism 3 is activated, an action command can be output to the driving mechanism 4, so that the push wheel drive motor 426 of the driving mechanism 4 drives the push wheel 425 to drive the tableware storage mechanism 5. Thus, the push wheel 425 is rotated to push the tableware box 52 in the tableware box storage module 51 into the tableware slide way 22, so that the tableware box 52 containing the tableware is output from the outlet 13 through the tableware slide way 22. In this way, the electronic control mechanism 3 can be used to activate the driving mechanism 4, and the tableware in the tableware storage mechanism 5 can be output by the driving mechanism 4, thereby effectively managing the supply of tableware, maintaining a sanitary environment for tableware storage, and meeting environmental protection requirements for tableware use.

When the detection module 43 detects that the tableware boxes 52 in the first row of the tableware box storage module 51 have been used up, the detection module 43 can output a signal to the electronic control module 33, so that the electronic control module 33 starts the screw drive motor 424, so that the screw drive motor 424 drives the push screw 423, so that the push screw 423 pushes the tableware box storage module 51, so that the tableware box storage module 51 uses the second slide rail set 422 to move toward the outlet 13. The tableware box storage module 51 is thereby arranged so that each tableware box 52 in the second row corresponds to the position of the push wheel 425 to complete the storage and movement of the tableware box storage module 51.

In addition, when all the tableware boxes 52 in the tableware box storage module 51 are used up, the detection module 43 can output a signal to the electronic control module 33, and the human-machine interface 31 can output an out-of-stock message. At this time, the fixing module 53 can be released to move the tableware box storage module 51 out of the carrier 41 in cooperation with the first slide rail set 421, so that each tableware box 52 can be stacked and arranged on the tableware box storage module 51, and then the tableware box storage module 51 can be fixed to the carrier 41 by the fixing module 53 to complete the transportation of tableware and provide it for reuse.

The present invention has been disclosed above with preferred embodiments, but those skilled in the art should understand that the embodiments are only used to describe the present invention and should not be interpreted as limiting the scope of the present invention. It should be noted that all changes and substitutions equivalent to the embodiments should be included in the scope of the present invention. Therefore, the protection scope of the present invention should be based on the scope of the patent application.

What the invention claimed is:

1. A tableware vending machine, comprising:
a machine body comprising a frame and a shell wrapped around an outer side of said frame, said shell comprising an outlet;
a carrying mechanism disposed on said frame and corresponding to said outlet;
an electronic control mechanism disposed on one side of said shell and adjacent to said outlet;
at least one driving mechanism disposed on said carrying mechanism and electrically connected to said electronic control mechanism; and
at least one tableware storage mechanism disposed on said driving mechanism.

2. The tableware vending machine as claimed in claim 1, wherein said carrying mechanism comprises a base and a tableware slide way, said base being disposed on said frame, said tableware slide way being disposed at one end of said base and corresponding to said outlet; said driving mechanism and said tableware storage mechanism are disposed on said base of said carrying mechanism.

3. The tableware vending machine as claimed in claim 1, wherein said electronic control mechanism comprises a human-machine interface, a billing module and an electronic control module, said human-machine interface, said billing module and said driving mechanism being electrically connected to said electronic control module.

4. The tableware vending machine as claimed in claim 1, wherein said driving mechanism comprises a carrier, a drive module and a detection module, said carrier being disposed on said carrying mechanism, said drive module being disposed between said carrier and said carrying mechanism, said detection module being disposed at one end of said carrier and being electrically connected to said electronic control mechanism; said tableware storage mechanism is assembled with said carrier of said driving mechanism.

5. The tableware vending machine as claimed in claim 4, wherein said drive module comprises a first slide rail set, a second slide rail set, a push screw, a screw drive motor, a push wheel and a push wheel drive motor, said first slide rail set being disposed between said carrying mechanism and said carrier, said second slide rail set being disposed between said tableware storage mechanism and said carrier, said push screw being connected to said tableware storage mechanism, said screw drive motor being connected to said push screw, said push wheel being disposed on said tableware storage mechanism, said push wheel drive motor being connected to said push wheel, said screw drive motor and said push wheel drive motor being electrically connected to said electronic control mechanism.

6. The tableware vending machine as claimed in claim 1, wherein said tableware storage mechanism comprises a tableware box storage module, a plurality of tableware boxes and a fixing module, said tableware box storage module being located on said driving mechanism, each said tableware box being respectively arranged on said tableware box storage module, said fixing module being arranged between said tableware box storage module and said driving mechanism.
